(19) United States
(12) Patent Application Publication
(10) Pub. No.: US 2012/0067092 A1
(43) Pub. Date: Mar. 22, 2012

(54) RAPID ACCESS KEY ENTRY TO BYPASS A LOCK

(76) Inventor: Brian M. Gomez, Mill Creek, WA (US)

(21) Appl. No.: 13/071,749

(22) Filed: Mar. 25, 2011

Related U.S. Application Data
(60) Provisional application No. 61/317,570, filed on Mar. 25, 2010.

(51) Int. Cl. E05B 19/20

(52) U.S. Cl. 70/394

(57) ABSTRACT

A lock bumping tool includes a key portion. The key portion has a cut length of a maximum depth at the key distal end and a strike portion that surrounds a proximal end of the key. The strike portion extends outwardly in the same plane as the key. When the key portion is placed in a keyway and the strike portion is activated by a planar force, the key portion creates a gap between an upper pin and a lower pin in the keyway allowing for a lock to be turned.

### RELATED APPLICATIONS

This application is the non-provisional of Application No. 61/317,570 filed Mar. 25, 2010, the entirety of which is hereby incorporated by reference as if included in its entirety herein.

### BACKGROUND OF THE INVENTION

The present invention relates to methods and materials for rapidly bypassing a cynlindrical pin-tumbler lock. The invention further relates to methods and materials that make use of and improve upon the locksmithing technique known as lock bumping and tools used therefore.

Lock bumping is well-known to the locksmithing industry; it allows a user to bypass a common pin-tumbler lock by inserting a specially cut key into the keyway and then gently turning the key while applying a swift kinetic force (a ‘bump’) to the keyhead. The technique was first described in a 1928 patent awarded to H. R. Simpson (U.S. Pat. No. 1,667,223) but lay relatively ignored until the early 2000s when European and American locksmithing communities began reassessing bumping as a major threat to the security of their commercial and residential buildings. Continued research, including that conducted by noted security expert and U.S. Investigative Attorney Marc Tobias, revealed that the great majority of residential and commercial pin-tumbler locks were completely vulnerable to lock bumping. Furthermore, materials were cheap to manufacture and easy to find. Today, these conditions have not subsided; a simple internet search for ‘bump keys’ will reveal countless storefronts and independent merchants offering the necessary tools for baseline prices.

### BRIEF DESCRIPTION OF THE DRAWINGS

FIG. 1a-d depict a three-dimensional view of a rapid access key, according to one embodiment of the present invention;

FIG. 2a-d depict a three-dimensional view of a rapid access key with sample dimensions for the key head, according to one embodiment of the present invention; and

FIG. 3 depicts a flowchart indicating an example order of steps that may be taken in practicing one embodiment of the present invention.

### DETAILED DESCRIPTION OF THE INVENTION

It is to be understood that this invention is not limited to particular methods, devices, or systems, which can, of course, vary. It is also to be understood that the terminology used herein is for the purpose of describing particular embodiments only, and is not intended to be limiting. In addition, unless defined otherwise, all technical and scientific terms used herein have the same meaning as commonly understood by one of ordinary skill in the art to which the invention pertains. Furthermore, it is to be understood that although the methods, systems, and other aspects of the invention are described herein, for purposes of clarity of illustration, with particular reference to flow cytometry, such reference is not intended to be limiting. Headings of sections provided in this patent application and the title of this patent application are for convenience only, and are not to be taken as limiting the disclosure in any way.

Members of the fire service and law enforcement industries must frequently gain entry to residences or commercial buildings—often under emergency circumstances. Where the occupants are unable or unwilling to grant the required access, members of the industry must rely on a variety of forcible entry tools. Such tools generally cause substantial damage to the lock, the door jamb, the door frame, and the door itself. The cost of this damage can easily reach into the thousands of dollars, increasing agency and insurance costs. There is thus a need for rapid bypass of locks that does not result in this type of damage. Even in the case of a non-emergency, service personnel may still frequently need to enter a building. If there is no ready access to the door, the only options may be to either wait for someone with ready access to assist them or to use destructive forcible entry tools, causing avoidable damage. Thus there is a need for non-intrusive, non-damaging bypass of locks, even under non-emergency situations.

Further, current lock bumping techniques require direct and precise kinetic force directed from a bumping tool to the bump key in the direction of the keyway. Traditional bump keys offer only a meager striking surface area to accomplish the bumping technique. Furthermore, the lack of any reinforcement near the striking area of the traditional bump key makes them prone to breaks—and thus frequent replacements. If bumping is to be used as an efficient method of lock bypass, there is a need for an improved bump key which offers a more generous and solid striking surface area and increased reinforcement and durability. There is still a need to improve and streamline the bypass of locks for those who legally have access to these tools and may have frequent and legitimate reasons to use them. Particularly this invention addresses challenges faced by members of the fire service and law enforcement industries when attempting to gain quick, effective, and cost-efficient (damage free) entry into residential and commercial buildings.

### Lock Bumping

An embodiment of the present invention makes use of rapping, bumping and/or lock bumping techniques. Bumping is a lock bypass method used to bypass pin tumber locks. A number of different bumping techniques exist (e.g. the pull-back method, minimal movement method, negative shoulder method, etc.). Regardless of these differences, bumping in some embodiments requires the user to utilize three components: a lock, a matching bump key, and a bump tool. Bumping is generally accomplished by: (1) inserting an exemplary embodiment of specially cut bump key (described below) into the keyway of the lock, (2) striking the head of the key with a bumping tool so the key is forced further into the lock, making contact with the pins, and (3) immediately or simultaneously turning the key to open the lock. When the bump key is struck and caused to enter the lock each pin is contacted by the key and the momentum of the bump key causes the upper most pin to jump and create a gap between it and the other pin or pins. During the brief period while the gap exists between the upper pin and the lower pin, the lock can be rotated.

### Locks, Locking Mechanisms, and Keyways

### Locks

An embodiment of the present invention applies primarily to an ability to bypass any of a variety of cylindrical or tubular locks. The advanced mechanics of cylindrical locks are described in U.S. Pat. Nos. 2,283,489 and 2,629,249 which are hereby incorporated by reference in their entirety herein. Some embodiments of the present invention include methods and materials that may be used to bypass different or unknown lock-types. For example, where a particular lock is “bump proof” or it is known that it can not be bumped successfully, instructions may be given to utilize more destructive forcible entry tools.

### Locking Mechanisms

An embodiment of the present invention can be used in conjunction with a variety of locking mechanisms. In one embodiment of the invention, the locking mechanism utilizes the pin tumbler design. Other locking mechanisms include the dimple lock, wafer tumbler lock, disc tumbler lock, etc.

### Keyways

The present invention applies to a variety of keyways and corresponding bump keys. Individual keyways frequently correspond with the manufacturer of the lock in which it is used. Keyways include but are not limited to those designed and/or manufactured by Kwikset, Schlage, Arrow, Defiant, Emtek, Falcon, Dexter, Weiser, Yale, Ilco, Baldwin, Best, National, Weslock, Sargent, American, Corbin Russwin, Emtek, and Master. Specifically, keyways may include one or more from the following list: American AM3 5-Pin, American AM7 6-Pin, Arrow AR1 5-Pin, Arrow AR4 6-Pin, Best BE2 7-Pin, Dexter DE6 5-Pin, ilco IN33 5-Pin, Kwikset KW1 5-Pin, Kwikset (Titan) KW10 6-Pin, Master M1 4-Pin, Master M2 4-Pin, Master M5 5-Pin, Master M10 5-Pin, Master M11 5-Pin, National NA12 5-Pin, Schlage SC1 5-Pin, Schlage SC4 6-Pin, Schlage SC19 5-Pin, Schlage SC20 6-Pin, Weiser WR5 5-Pin, Weslock WK2 5-Pin, Yale Y1 5-Pin, Yale Y11 5-Pin.

### Keys

The present invention, in some embodiments, makes use of specially cut keys commonly referreds to as ‘99999’ or ‘bump’ keys. Generally, bump key describes any key that fits into a particular pin tumber lock and has been modified so that all cuts are of the maximum depth (the ‘9’ setting) as typically varies and is disclosed by the manufacturer. Generally, a single bump key may be used for all locks of the same type (or keyway). Note that the traditional bump key will fit into a particular keyway but will not be able to unlock it without employing the bumping techniques described above.

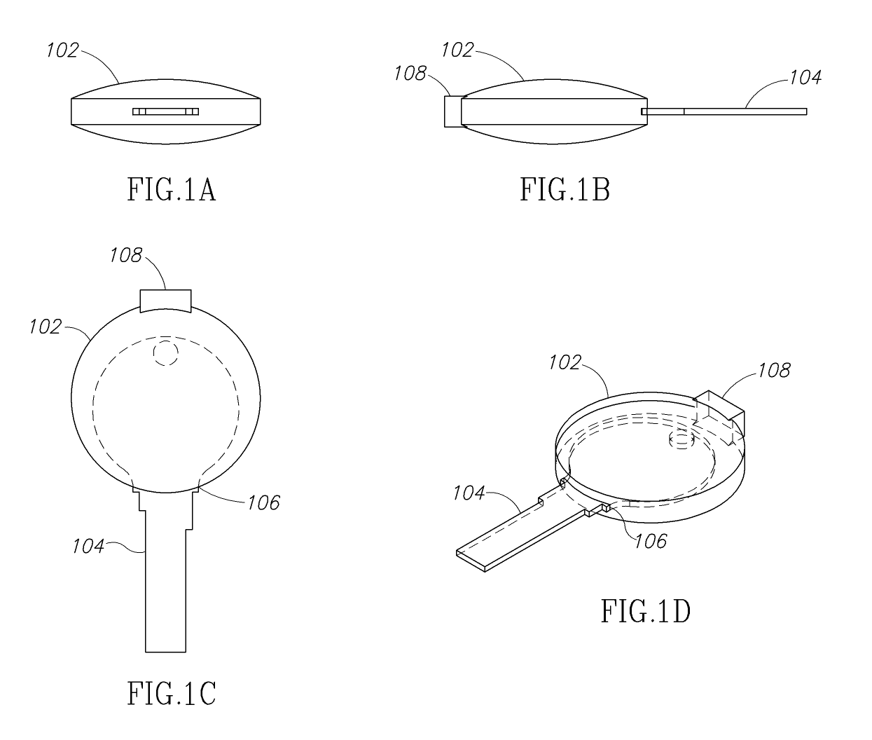

A Rapid Access Key (or “RAK”) is disclosed herein. For the purposes of this application, ‘RAK’ describes any common bump key which features an enlarged keyhead that has been specially modified or otherwise mounted or affixed to the key itself (See FIGS. 1,2, 3 and 4 for examples). The enlarged head of the RAK allows for a larger, more stable, and more pin-pointed striking surface to accomplish the bumping technique. In addition, it reinforces the bump key itself at the point of greatest impact.

It is contemplated that any of a variety of materials and methods may be used to manufacture and affix the enlarged keyhead component of the RAK. In one embodiment the enlargement is accomplished by pressing a plastic or clay moulding to the head of the key. In other embodiments, the head is specially constructed from a metal alloy, such as iron or aluminum.

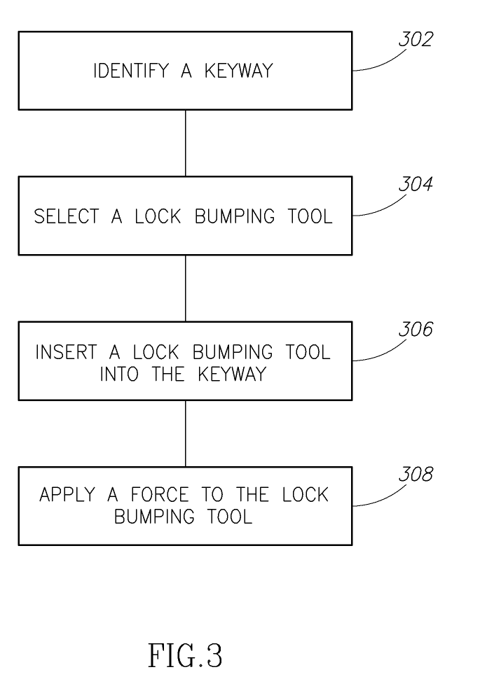

It is further contemplated that the enlarged keyhead may take on a variety of shapes and dimensions. In one embodiment the enlarged keyhead is generally circular with a flat edge protruding from the side opposite the key blade. This flat edge is what the user would strike with the bumping tool (described further below). See FIGS. 3 and 4. Ideally the flat edge would provide as large a striking surface area as possible without causing the key to become overly cumbersome or immobile. In a particular embodiment, the enlarged key head is generally circular in shape with an adjoining rectangular flat edge, said circular portion being at least 1.50″ in diameter and at least 0.25″ thick, and said rectangular portion being is at least 0.50″ long, at least 0.50″ wide, and at least 0.25″ thick. Other embodiments feature key heads with circular portions having diameters measuring 1.55, 1.60, 1.65, 1.70, 1.75, 1.80, 1.85, 1.90, 1.95, 2.00, 2.05, and 2.10″ and thicknesses measuring up to and including 1.50″ thick. Likewise, some embodiments feature key heads of which the adjoined rectangular portion has measurements of 0.50-3.50″ long, 0.50-3.50″ wide, and 0.25-1.5″ thick. In a particular embodiment the enlarged key head is generally spherical in shape, said sphere having radii measuring anywhere from 0.8-2.50″ in length. Finally, other contemplated embodiments includes RAKs with enlarged key heads taking the shape of any manufacturable or conceivable polyhedron.

Traditional sets of bump keys are frequently compiled in order for the user to adequately approach and bypass a larger number of cylindrical locks. A typical bump key set may include anywhere from 2-30 specially cut ‘99999’ keys that fit into the most frequently encountered keyway types. Often a user can identify which bump key he or she needs to use simply by identifying the manufacturer of the lock—frequently printed on the lock itself. Where the keyway is unknown, the user may need to attempt several bump keys to find one that fits into the keyway. An advantage of the present invention is the availability of a reference, or user guide, specifically designed to help the user determine which RAK to use on a given lock. This user guide is a simple and easy to read algorithm or chart that narrows down the choice of RAK for each type of lock that may typically encountered.

Another advantage of the present invention is the inclusion of what may be called Keyway Identification Keys (or “KID keys”). These keys are individual manufacturer key blanks without the enlarged head of the RAKs. Their purpose, especially in the context of a kit, is to more swiftly identify an unknown keyway. Because they do not feature the enlarged heads, the KID keys may easily fit on a single key ring and may each be used to quickly query a given lock. Once the keyway is identified, the correlating RAKs can then be used. It is contemplated that unique visual identifiers on the keyheads may ensure that the user can quickly match a KID key with its correlating RAK.

### Bumping Tools

The bumping technique required by some embodiments of the present invention requires some kinetic force be applied to the bump key to direct it further into the keyway and manipulate the lock pins. In an embodiment of the present invention, a tool is used to strike the key and create the required force. This tool may be a mallet, hammer, tomahawk tool, bump hammer or anything capable of providing the requisite kinetic force. In some preferred embodiments the tool used is a specially crafted bump hammer such as the TOMAHAWK bump hammer.

### Kits

One embodiment of the present invention is a kit that includes one or more of the specialty RAKs, described above. In addition, said kit may include one or more of the following tools:
R-tool: a forcible entry tool designed to pull all types of lock cylinders too large of the K-Tool unit, such as locks that extend out from the door and 1-inch round
A-type tool: a forcible entry tool shaped like an “A” or a “U” with sharp tapered blades that bite into lock cylinders of all shapes and sizes; extra leverage and original head design provide the mechanical advantage to pull well secured lock cylinders.
K-tool: a forcible entry tool designed to pull all types of lock cylinders (rim or mortise) from the various glass type or solid doors
Shove knife: a tool with the means of opening residential and/or office interior doors that use “key in the knob” locks, frequently slip spring latch locks. The traditional design makes the knife work from either side of the door. If the door opens inwards, you shove the knife in back of the molding stop and retract the latch. For doors that open towards you, the knife is slipped in from above or below the latch point and jiggled and pulled to retract the latch.
Box key tool: a square stock key tool used for opening police locks (type of rim lock)
Kerry key tool (large): an elongated tool that helps manipulate the inside of a lock after removing the outside lock cylinder
Kerry key tool (small): a (smaller) elongated tool that helps manipulate the inside of a lock after removing the outside lock cylinder
Bump hammer: specialized bumping tool with a weighted flat-end head
Electric Lock Pick Gun—Transfers sudden upwards energy to the bottom pins of a lock which in turn communicates this energy to the top pins of a lock causing those pins to jump. This tool is used in conjunction with a torsion wrench.
Torsion Wrench—An “L” shaped tool used to apply torsion to the inner cylinder of a lock, in order to hold any picked pins in place, while the other pins are shifted. The torsion wrench is then used to turn the inner cylinder and open the lock.
RAK Reference or User guide—A chart or algorithm for determining RAK choice.

In some embodiments of the present invention, a set of one or more KID keys (as described above) are included in the kit. In some embodiments the kit would include one matching KID key for each RAK included in the kit.

In and embodiment of the present invention, the invention is a kit which contains one or more RAK for each of the following keyways: American AM3 5-Pin, American AM7 6-Pin, Arrow AR1 5-Pin, Arrow AR4 6-Pin, Best BE2 7-Pin, Dexter DE6 5-Pin, ilco IN33 5-Pin, Kwikset KW1 5-Pin, Kwikset (Titan) KW10 6-Pin, Master M14-Pin, Master M2 4-Pin, Master M5 5-Pin, Master M10 5-Pin, Master M11 5-Pin, National NA12 5-Pin, Schlage SC1 5-Pin, Schlage SC4 6-Pin, Schlage SC19 5-Pin, Schlage SC20 6-Pin, Weiser WR5 5-Pin, Weslock WK2 5-Pin, Yale Y1 5-Pin, Yale Y11 5-Pin. In addition, said kit would include one of each of the tools noted in Paragraph 37. In addition, said kit would include one KID key for each of the RAKs included.

In another embodiment, a kit contains one RAK for each of the following keyways: American, Arrow, ASSA, Baldwin, Best, Corbin, Defiant, Dexter, Ilco, Kwikset, Master, National, Russwin, Sargent, Schlage, Weiser, Weslock, and Yale. In addition, said kit would include one of each of the tools noted in Paragraph 37. In addition, said kit would include one KID key for each of the RAKs included.

FIGS. 1a-d depicts a three-dimensional view of a rapid access key, according to one embodiment of the present invention. FIGS. 1a-d show a key portion 104, the key portion 104 having a cut length of a maximum depth to activate keyway pins at the key distal end; and a strike portion 102 surrounding a proximal end of the key at a joing pont 106, the strike portion extending outwardly in the same plane as the key. An adjacent rectangular shape portion 108 affixed to the strike portion 102 opposite the key portion 104. The rectangular shape portion 108 provides a surface to apply force upon, such that the force pushes the key portion into a keyway which creates a gap between an upper pin and a lower pin in the keyway.

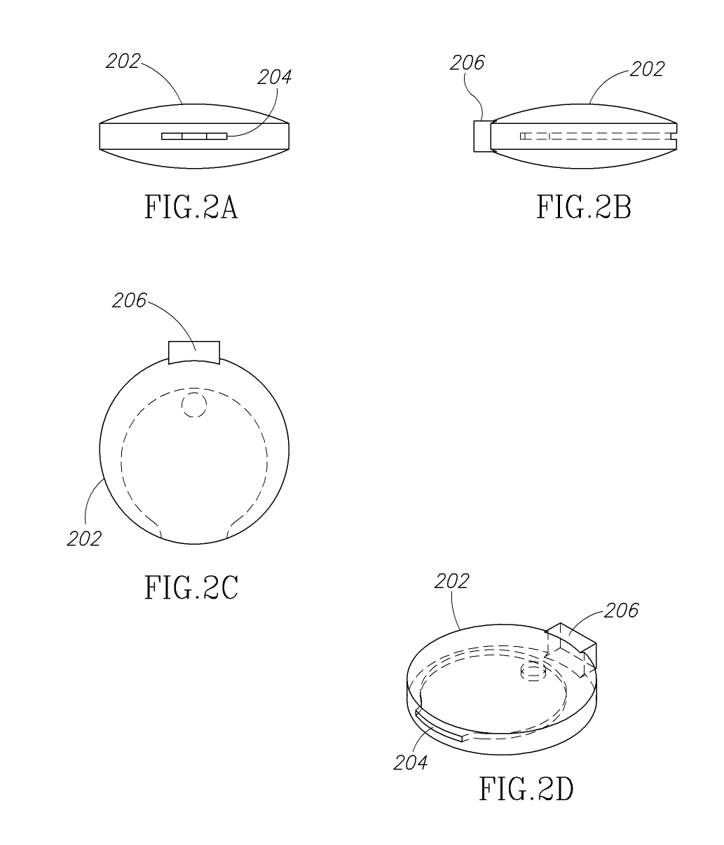

FIGS. 2a-d depict a three-dimensional view of a rapid access key with sample dimensions for the key head, according to one embodiment of the present invention. FIGS. 2a-d show a strike portion 202 defining a joing pont 204, the strike portion 204 surrounds a key portion the joining point 204. An adjacent rectangular shape portion 206 affixed to the strike portion 202.

FIG. 3 depicts a flowchart indicating an example order of steps that may be taken in practicing one embodiment of the present invention. The method begins at block 302 where a keyway is identified. The keyway may be identified using visual confirmation, a set of key blanks designed to identify a keyway, a user guide and/or the like. At block 304 a lock bumping tool is selected based on the identified keyway, the lock bumping tool having a key portion with a cut length of a maximum depth at the key distal end and a strike portion surrounding a proximal end of the key, the strike portion extending outwardly in the same plane as the key. At block 306, the lock bumping tool is inserted into the keyway. At block 308 a force is applied to the strike portion while simultaneously turning the key to open the lock.

### Other Embodiments

Although the present invention has been described in terms of various specific embodiments, it is not intended that the invention be limited to these embodiments. Modification within the spirit of the invention will be apparent to those skilled in the art. In addition, various different actions can be used to affect the data analysis, visualization and/or display described herein. For example, a voice command may be spoken by the user, a key may be depressed by the user, a button on a client-side scientific device may be depressed by the user, selection using any pointing device may be effected by the user, the process may be controlled by another machine, an algorithm, or through a network or wireless control system.

Those skilled in the art will readily appreciate that many modifications are possible in the exemplary embodiments without materially departing from the novel teachings and advantages of this invention.

1. A lock bumping tool comprising:
a key portion, the key portion having a cut length of a maximum depth at the key distal end; and
a strike portion surrounding a proximal end of the key, the strike portion extending outwardly in the same plane as the key,
wherein when the key portion is placed in a keyway and the strike portion is activated by a planar force, the key portion creates a gap between an upper pin and a lower pin in the keyway.

2. The lock bumping tool of claim 1, wherein the strike portion is generally circular in shape.

3. The lock bumping tool of claim 2, further comprising an adjacent rectangular shape portion affixed to the strike portion opposite the key portion.

4. The lock bumping tool of claim 3, wherein the strike portion is at least 1.50″ in diameter and at least 0.25″ thick; and wherein the rectangular shape portion is at least 0.50″ long, at least 0.50″ wide, and at least 0.25″ thick.

5. The lock bumping tool of claim 4, wherein the strike portion is made of a plastic moulding.

6. The lock bumping tool of claim 4, wherein the strike portion is made of a metal alloy.

7. A method of bypassing a lock comprising:
identifying a keyway;
selecting a lock bumping tool based on the identified keyway, the lock bumping tool having a key portion with a cut length of a maximum depth at the key distal end and a strike portion surrounding a proximal end of the key, the strike portion extending outwardly in the same plane as the key;
inserting a lock bumping tool into the keyway; and
applying a force to the strike portion while simultaneously turning the key to open the lock.

8. The method of claim 7, wherein the strike portion is generally circular in shape.

9. The method of claim 8, further comprising an adjacent rectangular shape portion affixed to the strike portion opposite the key portion.

10. The method of claim 9, wherein the strike portion is at least 1.50″ in diameter and at least 0.25″ thick; and wherein the rectangular shape portion is at least 0.50″ long, at least 0.50″ wide, and at least 0.25″ thick.

11. The method of claim 10, wherein the strike portion is made of a plastic moulding.

12. The method of claim 11, wherein the strike portion is made of a metal alloy.

13. A lock bumping kit comprising:
a plurality of key blanks configured to determine a keyway manufacturer; and
at least one lock bumping tool, the at least one lock bumping tool having a key portion with a cut length of a maximum depth at the key distal end and a strike portion surrounding a proximal end of the key, the strike portion extending outwardly in the same plane as the key,
wherein when a key blank is used to determine the keyway manufacturer, the lock bumping tool is inserted into the keyway to bump the lock.

14. The lock bumping kit of claim 13 further comprising at least one of an R-tool, A-tool, K-tool, shove knife, box key, kerry key, user guide and a bump hammer.

15. The lock bumping kit of claim 14, wherein the strike portion is generally circular in shape.

16. The lock bumping kit of claim 15, further comprising an adjacent rectangular shape portion affixed to the strike portion opposite the key portion.

17. The lock bumping kit of claim 16, wherein the strike portion is at least 1.50″ in diameter and at least 0.25″ thick; and wherein the rectangular shape portion is at least 0.50″ long, at least 0.50″ wide, and at least 0.25″ thick.

18. The lock bumping kit of claim 17, wherein the strike portion is made of a plastic moulding.

19. The lock bumping kit of claim 18, wherein the strike portion is made of a metal alloy.
